(19) United States
(12) Patent Application Publication
(10) Pub. No.: US 2011/0216827 A1
(43) Pub. Date: Sep. 8, 2011

(54) Method and apparatus for efficient encoding of multi-view coded video data

(76) Inventors: Jiancong Luo, West Windsor, NJ (US); Wanrong Lin, Belle Meade, NJ (US); Richard Edwin Goedeken, Santa Clarita, CA (US)

(21) Appl. No.: 12/932,168

(22) Filed: Feb. 18, 2011

Related U.S. Application Data
(60) Provisional application No. 61/307,227, filed on Feb. 23, 2010.

(51) Int. Cl. H04N 7/32

(52) U.S. Cl. 375/240.12; 375/E07.243

(57) ABSTRACT

A method and apparatus for efficient encoding of multi-view coded video data is provided. The apparatus includes one or more encoders (300) for encoding image data for a plurality of pictures for at least two views of multi-view video content. The image data is encoded in parallel in a plurality of at least one of threads and processes using a plurality of processors in order to generate a resultant bitstream there from.

### CROSS-REFERENCE TO RELATED APPLICATIONS

This application claims the benefit of U.S. Provisional Application Ser. No. 61/307,227, filed Feb. 23, 2010, which is incorporated by reference herein in its entirety.

### TECHNICAL FIELD

The present principles relate generally to video encoding and, more particularly, to a method and apparatus for efficient encoding of multi-view coded video data.

### BACKGROUND

Multi-view video coding (MVC) is the compression framework for the encoding of multi-view sequences. A multi-view video coding sequence is a set of two or more video sequences that capture the same scene from a different view point.

Multi-view coded video data carries information of multiple pictures for every video frame, each of which represents a “view” from a different perspective at the scene. If only two views are included, an MVC video data stream is normally called a stereoscopic, or 3D video stream, which represents the pictures as normally see in a 3D movie.

In contrast to single view video data streams, multi-view coded video data streams multiply the amount of source raw video data they represent. Further, in addition to intra-view prediction, inter-view prediction may be used to exploit the redundancy between views. Therefore, data dependency may exist between views.

Turning to FIG. 1, an example of intra-view prediction in multi-view video coding is indicated generally by the reference numeral 100. The intra-view prediction 100 involves four views, namely views V0, V1, V2, and V3, at four different time instances, namely, t0, t1, t2, and t3. The letter “I” is used to denote intra coded pictures, and the letter “P” is used to denote inter coded pictures.

Turning to FIG. 2, an example of intra-view prediction and inter-view prediction in multi-view video coding is indicated generally by the reference numeral 200. The intra-view prediction and inter-view prediction 200 involve four views, namely views V0, V1, V2, and V3, at four different time instances, namely t0, t1, t2, and t3. The letter “I” is used to denote intra coded pictures, and the letter “P” is used to denote inter coded pictures.

With inter-view prediction, only one view (V0 in FIG. 2), known as the base view, can be decoded independently without decoding other views. Other views, known as dependent views, depend on (by reference/prediction) one or more other views and cannot be decoded independently.

A widely known example of MVC encoding scheme is the MVC extension of the International Organization for Standardization/International Electrotechnical Commission (ISO/IEC) Moving Picture Experts Group-4 (MPEG-4) Part 10 Advanced Video Coding (AVC) Standard/International Telecommunication Union, Telecommunication Sector (ITU-T) H.264 Recommendation (hereinafter the “MPEG-4 AVC Standard”).

Due to the data dependency, sequential encoding is a common practice. In single-view coding, the sequential order used to encode pictures requires that a particular picture is encoded only after all of the reference pictures for the particular picture are encoded. In multi-view video coding, picture of all views captured at the same time are grouped into an access unit. Therefore, a straightforward implementation of a video encoder for multi-view coding is either time-first or view-first coding.

In time-first coding, the pictures of all views in an access unit are coded prior to the encoding the next access unit. Within an access unit, the order of encoding pictures needs to satisfy the constraint that a particular picture is encoded only after all the reference pictures for the particular picture are encoded. As illustrated in FIGS. 1 and 2, the order of time-first coding is V0t0-V1t0-V2t0-V3t0-V0t1-V1t1 . . . V2t3-V3t3.

In view-first coding, all pictures in a view are encoded prior to the encoding of the next view. Within a view, the order of encoding pictures is the same as that in the single-view coding. As illustrated in FIGS. 1 and 2, the order of view-first coding is V0t0-V0t1-V0t2-V0t3-V1t0-V1t1-V1t2 . . . V3t2-V3t3.

Although it is possible to have parallel encoding at the slice level, the temporal dependency among encoded pictures makes picture-level sequential encoding a natural choice, as generally a picture cannot be encoded unless its reference pictures are encoded.

On the other hand, multi-processor and/or multi-core general-purpose computers are increasingly common and inexpensive. As sequential encoding cannot take advantage of that, this left the multiplied computation power wasted.

### SUMMARY

These and other drawbacks and disadvantages of the prior art are addressed by the present principles, which are directed to a method and apparatus for efficient encoding of multi-view coded video data.

According to an aspect of the present principles, an apparatus is provided. The apparatus includes one or more encoders for encoding image data for a plurality of pictures for at least two views of multi-view video content. The image data is encoded in parallel in a plurality of at least one of threads and processes using a plurality of processors in order to generate a resultant bitstream there from.

According to another aspect of the present principles, a method performed by one or more encoders is provided. The method includes encoding image data for a plurality of pictures for at least two views of multi-view video content, wherein the image data is encoded in parallel in a plurality of at least one of threads and processes using a plurality of processors in order to generate a resultant bitstream there from.

These and other aspects, features and advantages of the present principles will become apparent from the following detailed description of exemplary embodiments, which is to be read in connection with the accompanying drawings.

### BRIEF DESCRIPTION OF THE DRAWINGS

The present principles may be better understood in accordance with the following exemplary figures, in which:

FIG. 1 is a diagram showing an example of intra-view prediction in multi-view video coding to which the present principles may be applied;

FIG. 2 is a diagram showing an example of intra-view prediction and inter-view prediction in multi-view video coding to which the present principles may be applied;

FIG. 3 is a block diagram showing an exemplary multi-view video encoder, in accordance with an embodiment of the present principles;

FIG. 4 is a block diagram showing an exemplary environment in which the present principles may be implemented, in accordance with an embodiment of the present principles;

FIG. 5 is a diagram showing an exemplary staggered multi-view video coding scheme, in accordance with an embodiment of the present principles;

FIG. 6 is a diagram showing another exemplary staggered multi-view video coding scheme, in accordance with an embodiment of the present principles; and

FIG. 7 is a diagram showing an exemplary method for encoding multi-view coded video data in parallel, in accordance with an embodiment of the present principles.

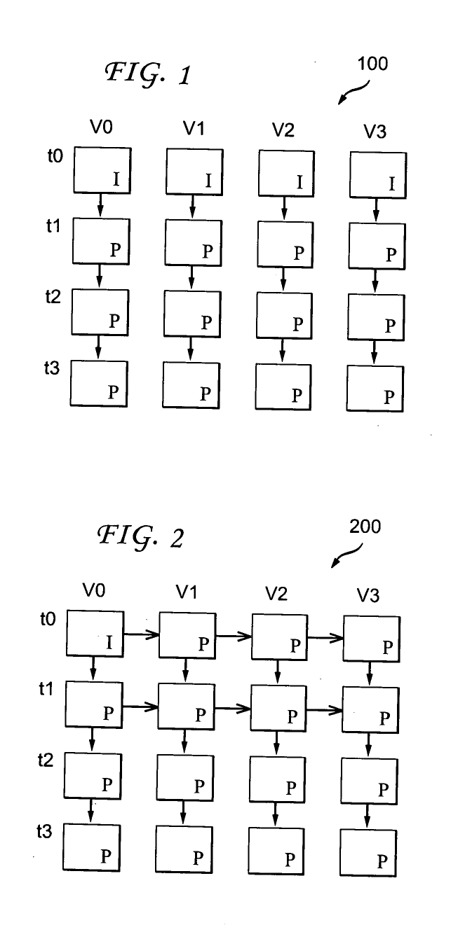

### DETAILED DESCRIPTION

The present principles are directed to a method and apparatus for efficient encoding of multi-view coded video data.

The present description illustrates the present principles. It will thus be appreciated that those skilled in the art will be able to devise various arrangements that, although not explicitly described or shown herein, embody the present principles and are included within its spirit and scope.

All examples and conditional language recited herein are intended for pedagogical purposes to aid the reader in understanding the present principles and the concepts contributed by the inventor(s) to furthering the art, and are to be construed as being without limitation to such specifically recited examples and conditions.

Moreover, all statements herein reciting principles, aspects, and embodiments of the present principles, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that the block diagrams presented herein represent conceptual views of illustrative circuitry embodying the present principles. Similarly, it will be appreciated that any flow charts, flow diagrams, state transition diagrams, pseudocode, and the like represent various processes which may be substantially represented in computer readable media and so executed by a computer or processor, whether or not such computer or processor is explicitly shown.

The functions of the various elements shown in the figures may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (“DSP”) hardware, read-only memory (“ROM”) for storing software, random access memory (“RAM”), and non-volatile storage.

Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

In the claims hereof, any element expressed as a means for performing a specified function is intended to encompass any way of performing that function including, for example, a) a combination of circuit elements that performs that function or b) software in any form, including, therefore, firmware, microcode or the like, combined with appropriate circuitry for executing that software to perform the function. The present principles as defined by such claims reside in the fact that the functionalities provided by the various recited means are combined and brought together in the manner which the claims call for. It is thus regarded that any means that can provide those functionalities are equivalent to those shown herein.

Reference in the specification to “one embodiment” or “an embodiment” of the present principles, as well as other variations thereof, means that a particular feature, structure, characteristic, and so forth described in connection with the embodiment is included in at least one embodiment of the present principles. Thus, the appearances of the phrase “in one embodiment” or “in an embodiment”, as well any other variations, appearing in various places throughout the specification are not necessarily all referring to the same embodiment.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed.

Moreover, as used herein, the words “picture” and “image” are used interchangeably and refer to a still image or a picture from a video sequence. As is known, a picture may be a frame or a field.

Further, as used herein, the phrase “partial order set” refers to a set of pictures where only some, but not all, of the pictures in the set have a dependency (i.e., upon one or more other pictures).

Also, as used herein, the word “dependency” refers to the condition where the encoding of a particular picture (e.g., a picture in the aforementioned set) is dependent on the prior encoding of one or more other pictures. For example, the other picture may be a reference picture for the particular picture and, in the case of multi-view coded video content, may pertain to either the same view or a different view. In the latter case, such a reference picture can be referred to as a cross-view or inter-view reference picture.

Additionally, as interchangeably used herein, “cross-view” and “inter-view” both refer to pictures that belong to a view other than a current view.

Moreover, as used herein, the word “Thread” refers to a sequence of instructions which may, in accordance with the present principles, be executed in parallel with other threads (i.e., other sequences of instructions).

Further, as used herein, the word “process” refers to a computer program or instance of a computer program which may, in accordance with the present principles, run concurrently with other computer programs.

Also, as interchangeably used herein, “processor” and “core” both refer to an electronic circuit or portion thereof capable of executing instructions and computer programs. It is to be appreciated that one or more “cores” may be part of a “processor” in some implementations. Additionally, it is to be appreciated that one or more processors may be part of a multi-processor integrated circuit chip in other implementations. These and other variations of processors and cores are readily determined by one of ordinary skill in this and related arts.

Moreover, it is to be appreciated that while one or more embodiments of the present principles are described herein with respect to the multi-view video coding extension of the MPEG-4 AVC Standard, the present principles are not limited to solely this extension and/or this standard and, thus, may be utilized with respect to other video coding standards, recommendations, and extensions thereof, while maintaining the spirit of the present principles. Further, it is to be appreciated that while the following description may thus refer to terms specific to the multi-view video coding extension of the MPEG-4 AVC Standard, such reference to such terms should also be considered for their corresponding generic multi-view video coding concepts when appropriate, as readily ascertained by one of ordinary skill in this and related arts.

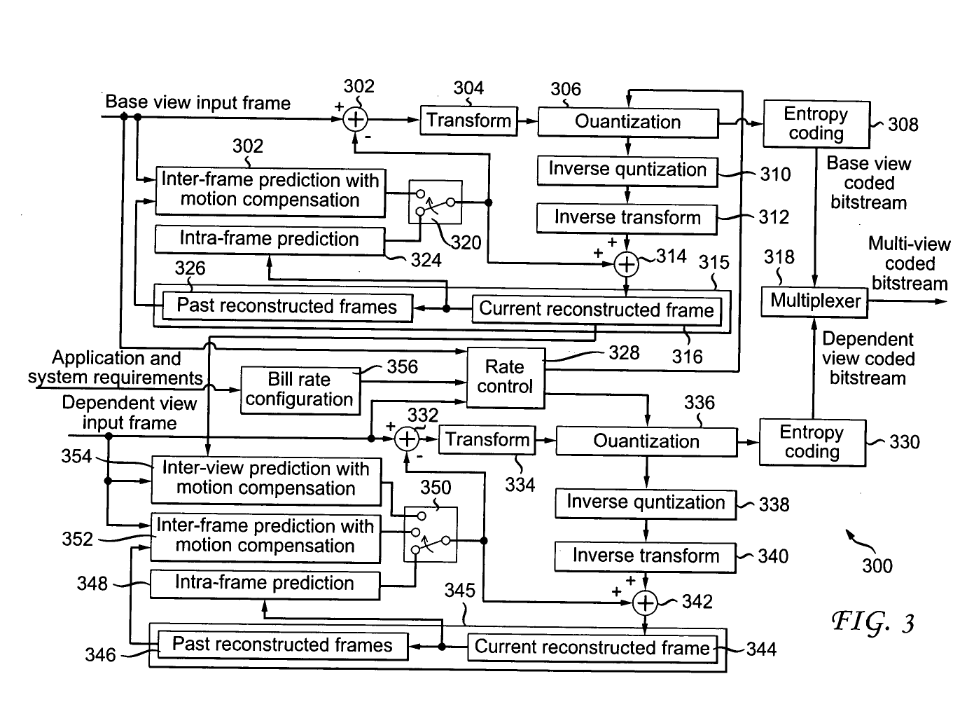

Turning to FIG. 3, an exemplary multi-view video encoder is indicated generally by the reference numeral 300. The video encoder 300 includes a combiner 302 having an output connected in signal communication with an input of a transformer 304. An output of the transformer 304 is connected in signal communication with a first input of a quantizer 306. A first output of the quantizer 306 is connected in signal communication with an input of an inverse quantizer 310. An output of the inverse quantizer 312 is connected in signal communication with an input of an inverse transformer 312. An output of the inverse transformer 312 is connected in signal communication with a first non-inverting input of a combiner 314.

An output of the combiner 314 is connected in signal communication with an input of a buffer 315. The buffer 315 stores a current reconstructed frame 316 output from the combiner 314 as well as past reconstructed frames 326 previously output from the combiner 314. A first output of the buffer 315 is connected in signal communication with an input of an intra-frame predictor 324. A second output of the buffer 315 is connected in signal communication with a first input of an inter-frame predictor with motion compensation 322. An output of the intra-frame predictor 326 is connected in signal communication with a first input of a switch 320. An output of the inter-frame predictor with motion compensation 322 is connected in signal communication with a second input of the switch 320. An output of the switch 320 is connected in signal communication with an inverting input of the combiner 302 and a second non-inverting input of the combiner 314. A second output of the quantizer 306 is connected in signal communication with an input of an entropy coder 308. An output of the entropy coder 308 is connected in signal communication with a first input of a multiplexer 318.

An output of a bit rate configurer 356 is connected in signal communication with a first input of a rate controller 328. A first output of the bit rate configure 356 is connected in signal communication with a second input of the quantizer 306. A second output of the rate controller 328 is connected in signal communication with a first input of a quantizer 336. A first output of the quantizer 336 is connected in signal communication with an input of an entropy coder 330. An output of the entropy coder 330 is connected in signal communication with a second input of the multiplexer 318. A second output of the quantizer 336 is connected in signal communication with an input of an inverse quantizer 338. An output of the inverse quantizer 338 is connected in signal communication with an input of an inverse transformer 340. An output of the inverse transformer 340 is connected in signal communication with a first non-inverting input of a combiner 342. An output of the combiner 342 is connected in signal communication with an input of a buffer 345. A first output of the buffer 345 is connected in signal communication with an input of an intra-frame predictor 348. An output of the intra-frame predictor 348 is connected in signal communication with a first input of a switch 350. A second output of the buffer 345 is connected in signal communication with a first input of an inter-frame predictor with motion compensation 352. An output of the inter-frame predictor with motion compensation 352 is connected in signal communication with a second input of the switch 350. A third output of the buffer 315 is connected in signal communication with a first input of an inter-view predictor with motion compensation 354. An output of the inter-view predictor with motion compensation 354 is connected in signal communication with a third input of the switch 350. An output of the switch 350 is connected in signal communication with an inverting input of a combiner 332 and a second non-inverting input of the combiner 342. An output of the combiner 332 is connected in signal communication with an input of a transformer 334. An output of the transformer 334 is connected in signal communication with an input of a quantizer 336.

A non-inverting input of the combiner 302, a second input of the inter-frame predictor with motion compensation 322, and a second input of the rate controller 328 are available as inputs of the MVC video encoder 300, for receiving a base view input frame. An input of the bit rate configure is available as an input of the MVC video encoder 300, for receiving application and system requirements. A third input of the rate controller 328, a non-inverting input of the combiner 332, a second input of the inter-view predictor with motion compensation 354, and a second input of the inter-view predictor with motion compensation 352 are available as inputs of the MVC encoder 300, for receiving a dependent view input frame. An output of the multiplexer 318 is available as an output of the MVC encoder 300, for outputting a multi-view coded bitstream.

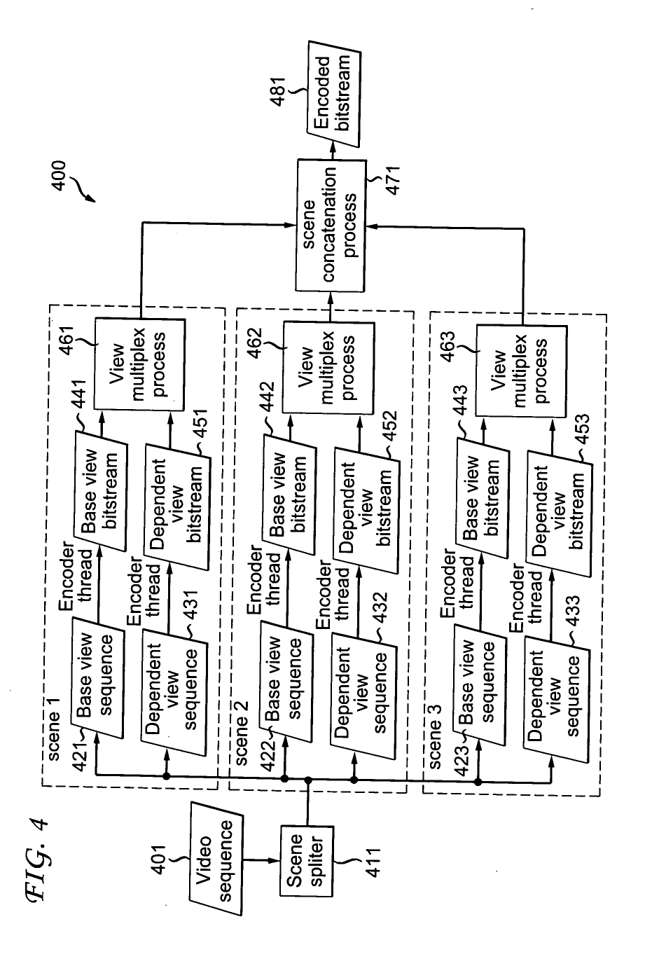

Turning to FIG. 4, an exemplary environment in which the present principles may be implemented is indicated generally by the reference numeral 400. The environment 400 includes a scene splitter that receives an input video sequence 401 and splits the input video sequence 401 into a first scene (scene 1), a second scene (scene 2), and a third scene (scene 3). Of course, while the input video sequence 401 is shown split into three scenes, the present principles may be applied to a video sequence having any number of scenes.

Scene 1 includes a base view sequence 421 corresponding to scene 1. A base view bitstream 441 is provided from the base view sequence 421 using a dedicated encoder thread. Scene 1 also includes a dependent view sequence 431 corresponding to scene 1. A dependent view bitstream 451 is provided from the dependent view sequence 431 using a dedicated encoder thread.

Scene 2 includes a base view sequence 422 corresponding to scene 2. A base view bitstream 442 is provided from the base view sequence 422 using a dedicated encoder thread. Scene 2 also includes a dependent view sequence 432 corresponding to scene 2. A dependent view bitstream 452 is provided from the dependent view sequence 432 using a dedicated encoder thread.

Scene 3 includes a base view sequence 423 corresponding to scene 3. A base view bitstream 443 is provided from the base view sequence 423 using a dedicated encoder thread. Scene 3 also includes a dependent view sequence 433 corresponding to scene 3. A dependent view bitstream 453 is provided from the dependent view sequence 433 using a dedicated encoder thread.

In an embodiment, for each of the scenes, the respective dedicated encoder threads used to provide the base view bitstream 441, 442, and 443 are different from the respective dedicated encoder threads used to provide the dependent view bitstreams 451, 452, and 453.

Moreover, in an embodiment, all of the dedicated encoder threads are different. Thus, as one example, the dedicated encoder thread used to provide the base view bitstream 441 is different than all of the other dedicated encoder threads (i.e., different than the respective dedicated encoder threads used to provide dependent view bitstream 451, base view bitstream 442, dependent view bitstream 452, base view bitstream 443, and dependent view bitstream 453).

The base view bitstream 441 and the dependent view bitstream 451 for scene 1 are input to a view multiplex process 461. The base view bitstream 442 and the dependent view bitstream 452 are input to a view multiplex process 462. The base view bitstream 443 and the dependent view bitstream are input to a view multiplex process 463. Respective outputs of the view multiplex process 461, the view multiplex process 462, and the view multiplex process 463 are input to a scene concatenation process 471. An output of the scene concatenation process 471 outputs an encoded bitstream 481. The encoded bitstream 481 is formed by concatenating (using the scene concatenation process 471) a separate bitstream for each of the scenes.

As noted above, the present principles are directed to a method and apparatus for efficient encoding of multi-view coded video data. The inventors have recognized that while multi-processor and/or multi-core general-purpose computers are increasingly common and inexpensive, sequential encoding cannot take advantage of the same, leaving this multiplied computation power wasted. The present principles address this issue by exploiting the parallelization opportunities in a multi-view video coding scheme.

Thus, in accordance with the present principles, we describe a method and apparatus for efficient encoding of multi-view motion pictures. The present principles improve encoding efficiency by parallelizing the data processing and exploiting the computation power from multiple hardware processing units (general purpose processors/cores and/or specialized hardware).

In video encoding, all pictures to be encoded form a partial order set, i.e., the dependency exists for some, but not necessarily for pictures in the set. This provides an opportunity to parallelize the encoding of different pictures. For example, any pair of pictures without (temporal and inter-view) dependency can be encoded in parallel. Although, the set can theoretically include all pictures to be encoded, in practice, the size of the set is usually constrained by the delay and memory size of the practical device. A sliding window can be used to define the set of pictures to be encoded. When a picture is encoded, it will be moved out of the window and a new picture to be encoded will be moved into the window. The pictures in the windows form a partial order set. Also, all pictures in the set that have no dependency can be dispatched to any available thread/process/processor resources to process in parallel. In general, the temporal dependency is considered total order, so that only the pictures of different views are processed in parallel. However, it is important to point out that the sliding window scheme is not restricted to the preceding. For some scenarios, such as Intra only coding, parallelization of picture encoding in temporal can be exploited.

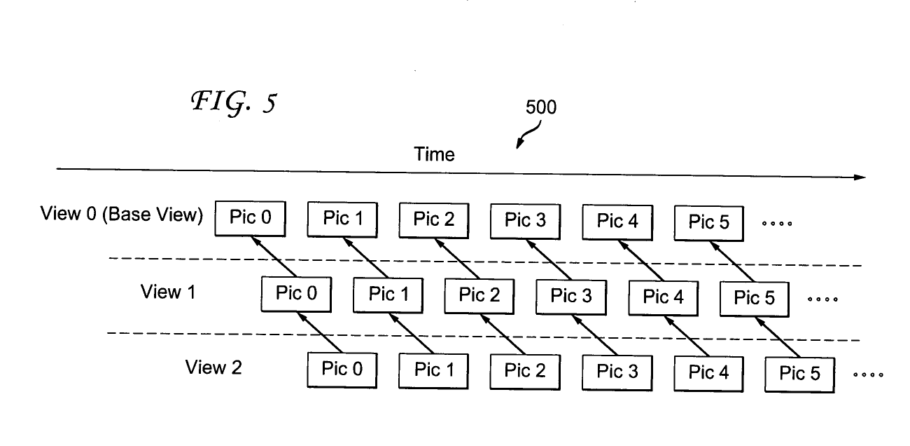

Turning to FIG. 5, an exemplary staggered multi-view video coding scheme is indicated generally by the reference numeral 500. The staggered MVC scheme 500 involves a base view (View 0) and two dependent views (View 1 and View 2).

By introducing a time lag between the encoding of different views, all the views in a video bitstream can be encoded simultaneously. The arrows in FIG. 5 show the dependency between view pictures captured at the same time. The arrows between pictures in the same view are omitted since the temporal dependency is considered total order within one view in the staggered MVC scheme 500.

At the time to encode picture 0 in View 1, picture 0 in View 0 is already encoded and ready for reference. The same applies to picture 0 in View 2, or any other pictures. If a thread/process is created to encode each view, multiple processors or other processing units can be utilized in this staggered scheme to significantly speed up (most likely by multiple times) the encoding compared with sequential encoding.

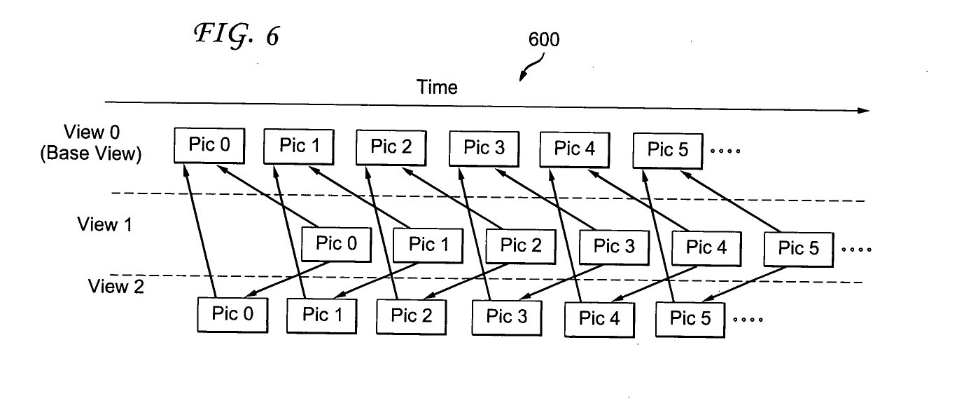

Turning to FIG. 6, another exemplary staggered multi-view video coding scheme is indicated generally by the reference numeral 600. The staggered MVC scheme 600 involves a base view (View 0) and two dependent views (View 1 and View 2). In the example of FIG. 6, both View 1 and View 2 depend directly on View 0, and View 1 also depends on View 2.

The arrows in FIG. 6 show the dependency between view pictures captured at the same time. The arrows between pictures in the same view are omitted since the temporal dependency is considered total order within one view in the staggered MVC scheme 600.

Intra-view prediction may also be present in the examples of FIGS. 5 and 6, although there is no indication for that in the FIGS. 5 and 6, as intra-view prediction does not affect the encoding timing illustrated in the figures.

In FIGS. 5 and 6, for simplicity, the encoding time of every picture is depicted as deterministic and constant, which is usually not the actual case. Due to the different picture types (I, P, B and so forth), bit rates, coding modes and other factors, the encoding time of every picture (either in the same view or a different view) can be very different. Also, pictures in a view may selectively depend on pictures from other views, i.e., in the same view, some pictures may use intra-view prediction only while other pictures use inter-view prediction only or both. The “jagged” encoding timing makes total parallelization of the encoding difficult or impossible. However, the parallelization can be improved by introducing a longer lag between the encoding thread/process, as a longer lag helps absorb the irregularity in the encoding timing.

In summary, the key point in the staggered MVC encoding is that every view is encoded in a separate encoding thread/process. The encoding timing is staggered so that the encoding of a picture only starts when its inter-view reference pictures are fully encoded (in other threads/processes).

In practice, the staggered timing usually does not need to be explicitly declared or configured, as the communication mechanism (semaphores and mutexes, for example) between the encoding threads/processes can automatically align the encoding threads/processes to the correct timing.

Further, in some video standards (such as the MPEG-4 AVC Standard and the MVC extension of the MPEG-4 AVC Standard), a picture can be divided into slices that can be encoded independent of each other. That means a picture can be encoded in parallel by multiple threads/processes, each of which encodes one slice. The parallelization at the slice level can be combined with that at the view level described before and further improves the encoding efficiency provided there are enough processing units.

It is important to point out the terminology “process/thread” as used herein is meant to be generic and not limited to pure software threads/processes. The encoding process can be carried out on either general-purpose processors and/or dedicated specialized hardware. For example, the base view data in an MPEG-4 AVC Standard bitstream is fully compatible with the regular MPEG-4 AVC Standard single view specification, and there are many (cheap) graphics card capable of decoding regular MPEG-4 AVC Standard single view bitstreams. It is conceivable that when decoding an MPEG-4 AVC Standard MVC bitstream on a general purpose computer, the base view data can be encoded by an add-on graphic card. Such a configuration would still be an example of the architecture described in accordance with the present principles.

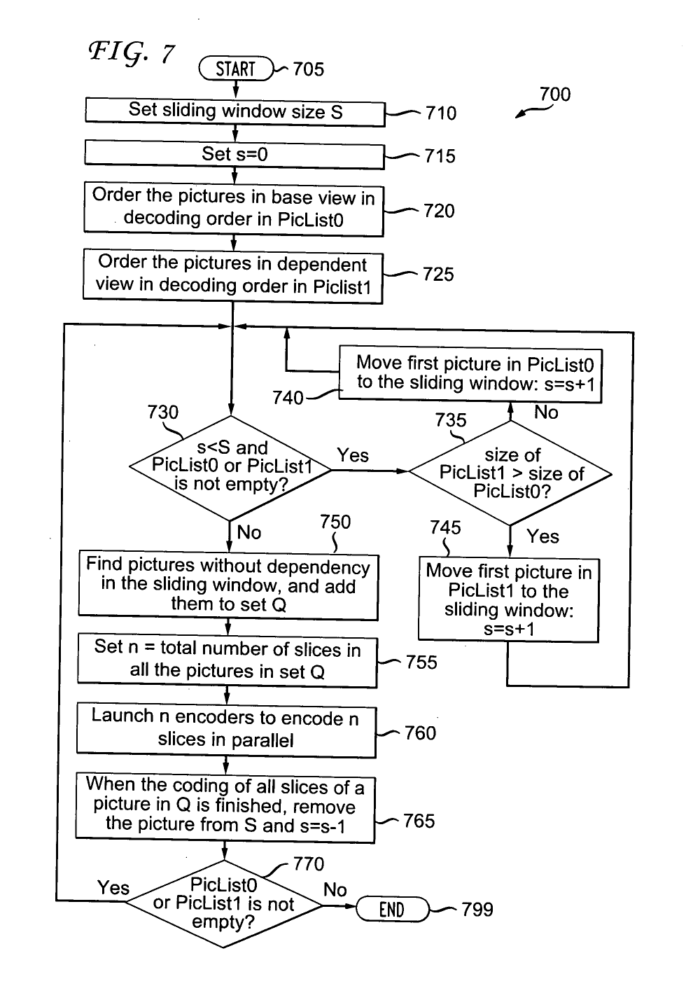

Turning to FIG. 7, an exemplary method for encoding multi-view coded video data in parallel is indicated generally by the reference numeral 700. The method 700 includes a start block 705 that passes control to a function block 710. The function block 710 sets a sliding window size S, and passes control to a function block 715. The function block 715 sets a variable s=0, and passes control to a function block 720. The function block 720 orders the pictures in the base view in decoding order in PicList0, and passes control to a function block 725. The function block 725 orders the pictures in the dependent view in decoding order in PicList1, and passes control to a decision block 730. The decision block 730 determines whether or not s<S (condition 1) and whether or not PicList0 or PicList1 is not empty (condition 2). If so (i.e., both conditions are met), then control is passed to a decision block 735. Otherwise (i.e., one or both conditions are not met), control is passed to a function block 750. The decision block 735 determines whether or not the size of PicList1>size of PicList0. If so, then control is passed to a function block 740. Otherwise, control is passed a function block 745.

The function block 740 moves the first picture in PicList0 to the sliding window, sets s=s+1, and returns control to the decision block 730. The function block 745 moves the first picture in PicList1 to the sliding window, sets s=s+1, and returns control to the decision block 730.

The function block 750 finds pictures without dependency in the sliding window, adds the found pictures to the set Q, and passes control to a function block 755. The function block 755 sets n=total number of slices in all the pictures in set Q, and passes control to a function block 760. The function block 760 launches n encoders to encode n slices in parallel, and passes control to a function block 765.

The function block 765 removes the picture from S, sets S=s−1, and passes control to a decision block 770. The decision block 770 determines whether or not PicList0 or PicList1 is not empty. If so, then control is returned to the decision block 730. Otherwise, control is passed to an end block 799.

A description will now be given of some of the many attendant advantages/features of the present invention, some of which have been mentioned above. For example, one advantage/feature is an apparatus having one or more encoders for encoding image data for a plurality of pictures for at least two views of multi-view video content, wherein the image data is encoded in parallel in a plurality of at least one of threads and processes using a plurality of processors in order to generate a resultant bitstream there from.

Another advantage/feature is the apparatus having the one or more encoders as described above, wherein all of the plurality of pictures form a set, and only particular pictures of the plurality of pictures in the set without dependency are processed in parallel.

Still another advantage/feature is the apparatus having the one or more encoders wherein all of the plurality of pictures form a set, and only particular pictures of the plurality of pictures in the set without dependency are processed in parallel as described above, wherein a sliding window is defined and only pictures currently framed by the sliding window are encoded.

Yet another advantage/feature is the apparatus having the one or more encoders wherein a sliding window is defined and only pictures currently framed by the sliding window are encoded as described above, wherein any of the plurality of pictures for a same one of the at least two views are encoded by at least one of a same thread and a same process from among the plurality of at least one of threads and processes.

Moreover, another advantage/feature is the apparatus having the one or more encoders as described above, wherein the resultant bitstream is compliant with a multi-view video coding extension of the International Organization for

Standardization/International Electrotechnical Commission Moving Picture Experts Group-4 Part 10 Advanced Video Coding Standard/International Telecommunication Union, Telecommunication Sector H.264 Recommendation.

Further, another advantage/feature is the apparatus having the one or more encoders as described above, wherein the image data for the plurality of pictures for each of the at least two views is respectively partitioned on a view-basis, and each slice in each of the plurality of pictures for a respective given one of the at least two views is encoded in separate ones of the plurality of at least one of threads and processes.

Also, another advantage/feature is the apparatus having the one or more encoders as described above, wherein each of the plurality of at least one of threads and processes correspond to a separate one of the one or more encoders.

Additionally, another advantage/feature is the apparatus having the one or more encoders as described above, wherein when encoding corresponding ones of the plurality of pictures for the at least two views, a time lag is introduced between encoding different ones of the at least two views to provide a resultant timing for encoding at least some of the corresponding ones of the plurality of pictures for the at least two views in parallel.

These and other features and advantages of the present principles may be readily ascertained by one of ordinary skill in the pertinent art based on the teachings herein. It is to be understood that the teachings of the present principles may be implemented in various forms of hardware, software, firmware, special purpose processors, or combinations thereof.

Most preferably, the teachings of the present principles are implemented as a combination of hardware and software. Moreover, the software may be implemented as an application program tangibly embodied on a program storage unit. The application program may be uploaded to, and executed by, a machine comprising any suitable architecture. Preferably, the machine is implemented on a computer platform having hardware such as one or more central processing units (“CPU”), a random access memory (“RAM”), and input/output (“I/O”) interfaces. The computer platform may also include an operating system and microinstruction code. The various processes and functions described herein may be either part of the microinstruction code or part of the application program, or any combination thereof, which may be executed by a CPU. In addition, various other peripheral units may be connected to the computer platform such as an additional data storage unit and a printing unit.

It is to be further understood that, because some of the constituent system components and methods depicted in the accompanying drawings are preferably implemented in software, the actual connections between the system components or the process function blocks may differ depending upon the manner in which the present principles are programmed. Given the teachings herein, one of ordinary skill in the pertinent art will be able to contemplate these and similar implementations or configurations of the present principles.

Although the illustrative embodiments have been described herein with reference to the accompanying drawings, it is to be understood that the present principles is not limited to those precise embodiments, and that various changes and modifications may be effected therein by one of ordinary skill in the pertinent art without departing from the scope or spirit of the present principles. All such changes and modifications are intended to be included within the scope of the present principles as set forth in the appended claims.

What is claimed is:

1. An apparatus, comprising:
one or more encoders for encoding image data for a plurality of pictures for at least two views of multi-view video content, wherein the image data is encoded in parallel in a plurality of at least one of threads and processes using a plurality of processors in order to generate a resultant bitstream there from.

2. The apparatus of claim 1, wherein all of the plurality of pictures form a set, and only particular pictures of the plurality of pictures in the set without dependency are processed in parallel.

3. The apparatus of claim 2, wherein a sliding window is defined and only pictures currently framed by the sliding window are encoded.

4. The apparatus of claim 3, wherein any of the plurality of pictures for a same one of the at least two views are encoded by at least one of a same thread and a same process from among the plurality of at least one of threads and processes.

5. The apparatus of claim 1, wherein the resultant bitstream is compliant with a multi-view video coding extension of the International Organization for Standardization/International Electrotechnical Commission Moving Picture Experts Group-4 Part 10 Advanced Video Coding Standard/International Telecommunication Union, Telecommunication Sector H.264 Recommendation.

6. The apparatus of claim 1, wherein the image data for the plurality of pictures for each of the at least two views is respectively partitioned on a view-basis, and each slice in each of the plurality of pictures for a respective given one of the at least two views is encoded in separate ones of the plurality of at least one of threads and processes.

7. The apparatus of claim 1, wherein each of the plurality of at least one of threads and processes correspond to a separate one of the one or more encoders.

8. The apparatus of claim 1, wherein when encoding corresponding ones of the plurality of pictures for the at least two views, a time lag is introduced between encoding different ones of the at least two views to provide a resultant timing for encoding at least some of the corresponding ones of the plurality of pictures for the at least two views in parallel.

9. A method performed by one or more encoders, comprising:
encoding image data for a plurality of pictures for at least two views of multi-view video content, wherein the image data is encoded in parallel in a plurality of at least one of threads and processes using a plurality of processors in order to generate a resultant bitstream there from.

10. The method of claim 9, wherein all of the plurality of pictures form a set, and only particular pictures of the plurality of pictures in the set without dependency are processed in parallel.

11. The method of claim 10, wherein a sliding window is defined and only pictures currently framed by the sliding window are encoded.

12. The method of claim 11, wherein any of the plurality of pictures for a same one of the at least two views are encoded by at least one of a same thread and a same process from among the plurality of at least one of threads and processes.

13. The method of claim 9, wherein the resultant bitstream is compliant with a multi-view video coding extension of the International Organization for Standardization/International Electrotechnical Commission Moving Picture Experts Group-4 Part 10 Advanced Video Coding Standard/International Telecommunication Union, Telecommunication Sector H.264 Recommendation.

14. The method of claim 9, wherein the image data for the plurality of pictures for each of the at least two views is respectively partitioned on a view-basis, and each slice in each of the plurality of pictures for a respective given one of the at least two views is encoded in separate ones of the plurality of at least one of threads and processes.

15. The method of claim 9, wherein each of the plurality of at least one of threads and processes correspond to a separate one of the one or more encoders.

16. The method of claim 9, wherein when encoding corresponding ones of the plurality of pictures for the at least two views, a time lag is introduced between encoding different ones of the at least two views to provide a resultant timing for encoding at least some of the corresponding ones of the plurality of pictures for the at least two views in parallel.
